(19) United States
(12) Patent Application Publication
(10) Pub. No.: US 2026/0159909 A1
(43) Pub. Date: Jun. 11, 2026

(54) CONTROLLING TEMPERATURE AND NOx CONTENT FOR A REDUCTION GAS

(71) Applicant: Primetals Technologies Austria GmbH, Linz (AT)

(72) Inventors: Robert MILLNER, Loosdorf (AT); Wolfgang STERRER, Gampern (AT)

(21) Appl. No.: 18/856,585

(22) PCT Filed: May 4, 2023
(86) PCT No.: PCT/EP2023/061809

§ 371 Date: Oct. 11, 2024

(30) Foreign Application Priority Data
May 5, 2022 (EP) 22171878.6

(51) Int. Cl. C21B 13/00; F27D 7/02; F27D 19/00

(52) U.S. Cl. CPC C21B 13/0073; F27D 7/02; F27D 19/00; C21B 2100/64; F27D 2019/0012

(57) ABSTRACT

A method for reducing a metal oxide-containing material in which a reduction gas that contains hydrogen is supplied to a reduction reactor, and a hydrogen-containing top gas is discharged from the reduction reactor. A sub-quantity of the top gas is supplied to gas burners, which are used in the preparation of the reduction gas, as a component of the fuel gas. If the content of hydrogen in the reduction gas and/or in the top gas increases, the content of water vapor in the fuel gas is increased. A device that performs the method includes a reduction reactor, a top gas discharge for discharging a top gas out of the reduction reactor, a preparation system which has at least one gas burner for preparing reduction gas, and a supply line for supplying a sub-quantity of the top gas to the at least one gas burner as a fuel gas component.

### FIELD OF INDUSTRY

The application relates to a process and apparatus for reduction of metal oxide-containing material,
wherein reduction gas is used.

### PRIOR ART

It is known that metal oxide-containing, for example iron oxide-containing, material—for example ores—can be reduced by means of reducing gases. For instance by means of direct reduction with reduction gas in a reduction unit, for example a reduction shaft. In the case of conventional methods that are currently employed on an industrial scale, the reduction gas is based predominantly on carbon-for example in carbon monoxide CO or methane CH₄—from natural gas. Therefore, large volumes of carbon dioxide CO₂ are obtained, which is undesirable for reasons of environmental policy among others.

In order to reduce the output of CO₂ in the reduction of metal oxide-containing material, it is known that hydrogen H₂ can be used as reducing gas. Hydrogen can be used here as the sole reduction gas, or in combination with other gases that are based, for example, on carbon from natural gas. The greater the proportion of hydrogen H₂ that is CO₂-neutral with respect to reduction reactions in the reduction gas, the less CO₂ is emitted. According to the availability of natural gas and hydrogen, the ratio of its contribution to the reduction gas can be varied by mixing different amounts.

The more hydrogen is available, the more it is possible to dispense with a contribution based on carbon from natural gas which is climatically problematic.

It is favorable to operate existing plants and procedures in which the reduction gas is based predominantly on carbon from natural gas with elevated proportions of hydrogen in the reduction gas as well. This enables flexible reaction to the availability of natural gas and hydrogen, and permits the exploitation of plant investments that have already been made. At least until sufficient volumes of hydrogen are available for use of reduction gases based entirely on hydrogen, reduction gas will still have to rely on carbon from natural gas.

It is customary to feed reduction gas to a reduction reactor containing the metal oxide-containing material, and to discharge a tops gas from the reduction reactor. The tops gas is formed from the reduction gas as it passes through the reduction reactor because of the reactions of its components that take place in the reduction reactor with the metal oxide-containing material—or the products formed in these reactions, for example the metallic iron formed. As a result of the reduction reactions that took place in the reduction reactor, the tops gas has lower reducing power than the reduction gas, and it has a calorific value. For utilization of the reduction power, tops gas is often used as a component in the preparation of fresh reduction gas.

The reduction gas is often heated by means of gas burners in a gas heating apparatus in order to obtain the temperature desired for the reduction reactions.

In processes in which the production of the reduction gas is based on reforming of a precursor gas-for example natural gas, energy is often provided by gas burners for the reforming.

Gas burners require a fuel gas and an oxidation gas—for example air; in the combustion, the fuel gas is oxidized, which releases energy.

It is known that tops gas suitable owing to its calorific value can be utilized as fuel gas.

As the proportion of hydrogen in the reduction gas rises, there is also an increase in the proportion of hydrogen in tops gas. When it is used as fuel gas, this has the disadvantage that the adiabatic flame temperature will rise in the course of combustion. The rise in the adiabatic flame temperature can have an unfavorable effect:
When air is used as oxidation gas, a considerable amount of nitrogen is present; as the adiabatic flame temperature rises, more unwanted nitrogen oxides NOx are formed. The nitrogen may alternatively come from combustible nitrogen gases, for instance ammonia H₃, that are present in the fuel gas—called fuel nitrogen—or from gaseous nitrogen N₂ in the fuel gas.
For the purpose of energy optimization, gases such as oxidation gas, fuel gas and precursors of the reduction gas are often heated by heat exchange with the offgas from the gas burners. The heat is often transferred here via radiation. Rising adiabatic flame temperature can have an unfavorable effect on radiation-based heat transfer.

### SUMMARY OF THE INVENTION

### Technical Object

It is an object of the present invention to present a contribution to the reduction of at least some of the aforementioned problems.

### Technical Achievement of Object

The object is achieved by a
process for reducing metal oxide-containing material,
wherein a reduction gas containing at least hydrogen, and optionally also carbon carriers,
is fed to a reduction reactor containing the metal oxide-containing material, and
a hydrogen-containing tops gas is discharged from the reduction reactor,
characterized in that
a portion of the tops gas is fed to gas burners used in the preparation of the reduction gas as a component of the fuel gas, and,
in the event of an increase in the proportion of hydrogen in the reduction gas and/or in the tops gas, an increase in the steam content of the fuel gas is implemented.

The metal oxide-containing material is preferably iron oxide-containing material.

The reduction gas contains at least hydrogen as reducing component. It may also consist of hydrogen. The reduction gas optionally also contains one or more gaseous carbon carriers as additional reducing component or components. Carbon carriers are contributed, for example, by natural gas; these are, for example, carbon monoxide CO or methane CH₄ that have been introduced by natural gas or produced from natural gas.

The hydrogen may, for example, be green, blue, gray, turquoise or pink hydrogen. These “colors” mean the coloring associated with the underlying mode of production. Green hydrogen is generated, for example, by electrolysis of water by means of power from renewable energies, or by gasification or fermentation of biomass, or steam reforming of biogas—what is common to the modes of production of green hydrogen is that the production is CO₂-free. In the case of blue hydrogen, CO₂ formed in production is stored, such that it does not get into the atmosphere; for example when it has been generated with sequestration of carbon dioxide CO₂ formed. In the case of turquoise hydrogen is generated with deposition of carbon C form. In the case of pink hydrogen, hydrogen is generated using atomic power. In the case of gray hydrogen is produced from fossil fuels-for example from natural gas by steam reforming
where the CO₂ formed is predominantly released into the atmosphere.

Other colors of hydrogen are also possible.

Likewise possible is a mixture of one or more of these “colors” of hydrogen.

When carbon carriers are present as additional reducing components: the ratio of the proportions of hydrogen and carbon carriers in the reduction gas can be varied, for example, by combining different amounts in the preparation of the reduction gas. For example, variation is possible such that the proportion of hydrogen in the reduction gas increases.

The reduction gas is the gas introduced into the reduction reactor with its composition and temperature on introduction. Before this composition and temperature are defined, the reduction gas is in the form of a precursor, on the basis of which the reduction gas is prepared. The preparation may comprise, for example, addition of further components, heating, reforming. The preparation may also comprise chemical reactions that proceed in the precursor without outside intervention, which alter the chemical composition or the temperature for example. In the case of changes in the formulation, the proportion of hydrogen in the reduction gas may vary.

At least in the preparation of the reduction gas, gas burners are used, for example in heating and/or reforming.

The reduction reactor is, for example, a reduction shaft-for example, in the case of performance of a direct reduction process, with a reaction shaft containing a fixed bed of metal oxide-containing material. The reduction reactor is, for example, a moving bed reactor—for example, in the case of performance of a direct reduction process, with a reduction reactor containing a moving bed of metal oxide-containing material. The moving bed reactor may also comprise multiple individual component reactors that are connected, for example, in parallel or sequentially and collectively form the moving bed reactor.

The reduction reactor is, for example, a fluidized bed reactor—for example, in the case of performance of a direct reduction process, with a reduction reactor containing a fluidized bed of metal oxide-containing material. The fluidized bed reactor may also comprise multiple individual component reactors that are connected, for example, in parallel or sequentially and collectively form the fluidized bed reactor.

A tops gas is discharged from the reduction reactor. The tops gas is formed from the reduction gas as it flows through the reduction reactor on account of the reactions that take place in the reduction reactor of its components with the metal oxide-containing material, or the products formed in these reactions, for example the metallic iron formed. As a result of the reduction reactions that have taken place in the reduction reactor, the tops gas has less reducing power than the reduction gas. The tops gas contains hydrogen.

Gas burners require a fuel gas for the combustion. A portion of the tops gas is fed to gas burners used in the preparation of the reduction gas as a component of the fuel gas required for the combustion; in the case of multiple gas burners, to at least one gas burner. For example, a portion of 10 m³ (STP) of 100 m³ (STP) of tops gas is used as a component of the fuel gas.

Before use as a component of the fuel gas, treatment steps may be implemented on the tops gas; for example, the tops gas may be dedusted, the tops gas may be heated, the tops gas may be cooled, steam content of the tops gas may be adjusted.

The portion of the tops gas may be one of several components of the fuel gas, for example when a further gas—for example natural gas—with a calorific value is mixed in, and then the gas mixture is utilized as a fuel gas.

The portion of the tops gas may also be the sole component of the fuel gas; in that case, the fuel gas corresponds to this portion.

When there are several components of the fuel gas: combination of all components of the fuel gas gives rise to the fuel gas; before all the components are combined, the fuel gas is in the form of a precursor.

Measures for increasing the steam content in one or more components of the fuel gas or in a precursor of the fuel gas also lead to an increase in the steam content of the fuel gas.

In the event of an increase in the proportion of hydrogen in the reduction gas and/or in the tops gas, an increase in the steam content of the fuel gas is implemented. For this purpose, measures are effected that cause the presence of additional steam in the fuel gas compared to a comparative state. The steam content of the fuel gas is preferably increased under open-loop and/or closed-loop control, i.e. with utilization of an apparatus for open-loop and/or closed-loop control of the steam content in the fuel gas. In this case, there is open-loop and/or closed-loop control to a target value or range of target values. The target value or range of target values arises, for example, from the desired degree of reduction in the adiabatic flame temperature and/or from the desired limitation of temperature spikes within the flame.

An increase in the proportion of hydrogen in the reduction gas and/or in the tops gas is bound by means of an apparatus for finding an increase in the proportion of hydrogen in the reduction gas and/or in the tops gas, or by means of an apparatus for determining the hydrogen content in the reduction gas and/or in the tops gas. In the case of determination of hydrogen content in the reduction gas and/or in the tops gas, it is also possible to find an increase in the proportion of hydrogen in the reduction gas and/or in the tops gas.

The hydrogen H₂ content in the fuel gas is preferably at least 65% by volume, more preferably at least 20% by volume-based in each case on a water content of 0% by volume in the fuel gas.

### Advantageous Effects of the Invention

An increase in the steam content of the fuel gas, on combustion, has the result that the adiabatic flame temperature is lower compared to an identical fuel gas apart from the elevated steam content. The problems described at the outset with regard to nitrogen oxide formation and heat transfer in the event of a higher adiabatic flame temperature owing to a rising hydrogen content can thus be reduced or avoided.

It is also advantageous here that the reduction in the adiabatic flame temperature which is enabled in accordance with the invention does not require any reduction in the temperature level of the fuel gas and of the oxidation gas. It is thus possible to withdraw a constant amount of heat from the offgas from the gas burners by heat exchange, which is favorable with regard to release of the offgases into the environment. Release of the offgases at higher temperature-because less heat is withdrawn into fuel gas and oxidation gas in order to achieve a reduction in the flame temperature via a lower temperature of these gases—is unfavorable owing to a smaller amount of energy withdrawn by heat exchange.

Typically, the steam content of the tops gas is adjusted to a target value in order to assure very reproducible properties for efficiently controllable further utilization of the tops gas. For this purpose, it is typically subjected to conditioning in countercurrent with water, which is conducted in a gas conditioner. Different portions of the tops gas that are provided, for example, for various utilizations with different demands on the steam content—for example utilization as a component of the reduction gas, utilization as a component of a fuel gas—are typically conditioned in different gas conditioning channels with water at different temperatures.

In one embodiment, the increase in the steam content in the fuel gas is implemented by increasing the temperature of the water used in the conditioning of the portion of the tops gas. The portion of the tops gas leaving the gas conditioner is saturated; with rising water temperature, there is a rise in the temperature of the portion of the tops gas leaving the gas conditioner and hence the amount of steam present at saturation.

Typically, in the conditioning, the tops gas provided for utilization as a component of the reduction gas is conditioned in dedicated gas conditioning channels using hot water. By comparison with a first state with a particular steam content of the tops gas before conditioning and with a particular target for the steam content after conditioning: the higher the steam content of the tops gas before conditioning—i.e. the more water has to be condensed out for the establishment of an unchanged target, the more favorable it is to use water with a lower temperature compared to the first state for the conditioning. There is thus a drop in the demand for the hot water provided for production of the first state. In one embodiment, the temperature of the water which is used for the conditioning of the portion of the tops gas provided as a component of the fuel gas is increased by using hot water provided for the conditioning of tops gas provided as a component of the reduction gas—this may account for a portion of the water for conditioning of the tops gas, or may be the entirety of the water for conditioning of the tops gas.

In this way, it is possible to make sensible use of the infrastructure for production of hot water even when there is a drop in the demand for hot water for conditioning of the reduction gas.

In one embodiment, the increase in the steam content of the fuel gas is implemented by adding water H₂O to the fuel gas—or to a component or a precursor of the fuel gas. It is thus possible to add water H₂O to one or more or all members of the group consisting of the following three members:
fuel gas,
component of the fuel gas,
precursor of the fuel gas.

The water can be added in liquid form, H₂O_{f}. The water H₂O can be added as steam, H₂O_{g}. Combination of all components of the fuel gas gives rise to the fuel gas. Before all components are combined, the fuel gas is in the form of a precursor.

In one variant of the process of the invention, the fuel gas—or a precursor of the fuel gas—is heated before the fuel gas is combusted. This is accomplished, for example, by means of heat exchange with offgas from a reformer and/or a gas heating apparatus; for example offgas from reformer and/or gas heating apparatus that are operated with the gas burners supplied with the fuel gas. Preferably, water H₂O is added to the fuel gas—or to a precursor of the fuel gas—after the fuel gas—or the precursor of the fuel gas—has been heated. Owing to the higher temperature, it is then possible to take up more water H₂O. This is particularly favorable when a component of the fuel gas is hydrogen H₂, which is added since hydrogen H₂is usually largely dry and hence the percentage water content thereof falls after it has entered a gas mixture.

As mentioned, treatment steps, for example a dedusting operation, can be implemented on the tops gas before it is used as a component of the fuel gas. In one embodiment, the tops gas provided for use as a component of the fuel gas is subjected to at least partial dry dedusting. In dry dedusting, virtually no loss of steam content occurs, which would have to be compensated for again thereafter when the steam content is increased; it is therefore advantageous to subject the portion of the tops gas provided as a component of the fuel gas to dry dedusting. When a component of the fuel gas is hydrogen H₂, which is added, it is advantageous to add it after dry dedusting. This is because hydrogen H₂is usually largely dry and hence the percentage water content thereof falls after it has entered a gas mixture. After dry dedusting, the steam content is generally high enough for a lowering as a result of addition of hydrogen to entail only a small degree of complexity, if any, for meeting or exceedance of a desired minimum value.

In the case of dry dedusting, virtually no loss of tangible heat occurs. In the case of dry dedusting, a lesser degree of preheating of the fuel gas, if any, is therefore required. The energy remaining in the tops gas can be utilized, for example, for preheating of hydrogen, combustion air or process gas or reduction gas.

The present application further provides an apparatus for reduction of metal oxide-containing material, comprising:
a reduction reactor,
a tops gas outlet for discharge of tops gas from the reduction reactor,
a preparation plant for preparation of reduction gas, comprising at least one gas burner,
a supply conduit for supply of a portion of the tops gas as fuel gas component to the at least one gas burner,
   characterized in that it also comprises
at least one member from the group consisting of the following two members:
   a) at least one apparatus for determination of the steam content in the reduction gas and/or in the tops gas, and
   b) an apparatus for detection of any increase in the content of hydrogen in the reduction gas and/or in the tops gas,
an apparatus for open-loop and/or closed-loop control of the steam content in the fuel gas with reference to the hydrogen content in the reduction gas and/or in the tops gas.

The apparatus for reduction of metal oxide-containing material may comprise one or more reduction reactors.

The apparatus for reduction of metal oxide-containing material also comprises a reduction gas feed via which the reduction reactor is fed with reduction gas.

The apparatus for reduction of metal oxide-containing material may comprise one or more tops gas outlets.

The apparatus for reduction of metal oxide-containing material may comprise one or more preparation plants for preparation of reduction gas.

A preparation plant for preparation of reduction gas may comprise one or more gas burners.

The apparatus for reduction of metal oxide-containing material may comprise one or more supply conduits for supply of a portion of the tops gas as fuel gas component to the at least one gas burner; these are suitable for feeding a portion of the tops gas to the gas burners together with other components of the fuel gas as fuel gas. Other components of the fuel gas may, for example, be fed through feed conduits that open into the supply conduit that guides the portion of the tops gas, which gives rise to the fuel gas.

The apparatus for reduction of metal oxide-containing material comprises at least one apparatus for determining the steam content in the reduction gas and/or in the tops gas; it may also comprise two or more such apparatuses. The determination of the steam content may be based, for example, on a calculation based on gas temperature and/or water temperature.

The apparatus for reduction of metal oxide-containing material comprises an apparatus for open-loop and/or closed-loop control of the steam content in the fuel gas with reference to the hydrogen content in the reduction gas and/or in the tops gas; it may also comprise several such apparatuses.

Such an apparatus can achieve the aim of open-loop and/or closed-loop control of the steam content in the fuel gas with reference to the hydrogen content in the reduction gas and/or in the tops gas. In this way, it is possible to conduct a process of the invention.

Of course, there is also a reduction gas feed via which reduction gas—containing at least hydrogen and optionally also carbon carriers—is supplied to the reduction reactor in the apparatus of the invention for reduction of metal oxide-containing material.

in one variant of the apparatus of the invention for reduction of metal oxide-containing material, there is also a feed conduit for conduction of further fuel gas components to the gas burner. In one variant, an apparatus of the invention for reduction of metal oxide-containing material comprises an apparatus for detecting an increase in the proportion of hydrogen in the reduction gas and/or in the tops gas. This can be used to detect whether an increase in the proportion of hydrogen occurs in the reduction gas and/or in the tops gas. The apparatus for detecting an increase in the proportion of hydrogen in the reduction gas and/or in the tops gas may be integrated within the apparatus for determining the steam content in the reduction gas and/or in the tops gas, such that there is thus only a single apparatus with two suitabilities—or it may be executed separately from the apparatus for determination of the steam content in the reduction gas and/or in the tops gas, such that there are thus two apparatuses—one apparatus for detecting an increase in the proportion of hydrogen in the reduction gas and/or in the tops gas, and one apparatus for determining the hydrogen content in the reduction gas and/or in the tops gas.

The apparatus for detecting an increase in the proportion of hydrogen in the reduction gas and/or in the tops gas is preferably an apparatus for determining the hydrogen content in the reduction gas and/or in the tops gas.

In one embodiment, the apparatus comprises at least one gas conditioner for open-loop and/or closed-loop control of the steam content in the fuel gas with reference to the hydrogen content in the reduction gas and/or in the tops gas. In a gas conditioner, gas is conditioned with regard to its steam content, meaning that a measure is taken that leads to attainment of a target value for the steam content. The measure in a gas conditioner is to conduct the gas stream to be conditioned in countercurrent with water. Heat and water are exchanged here between the gas phase and the liquid phase.

In an apparatus of the invention, the gas conditioner is configured such that it can be operated at different water temperatures. For this purpose, it may, for example, have different water feeds each connected to water from water sources at different temperatures. For this purpose, it may have, for example, heating devices and/or cooling devices for heating and/or cooling of water fed in.

In one embodiment, the gas conditioner has
fuel gas conditioning channels for conditioning of tops gas provided as a component of the fuel gas with a water feed for fuel gas conditioning,
and reduction gas conditioning channels for conditioning of tops gas provided as a component of the reduction gas with a hot water feed for reduction gas conditioning,
wherein the hot water feed for reduction gas conditioning is suitable for supplying hot water for fuel gas conditioning to at least one fuel gas conditioning channel.

In one embodiment, the apparatus for reduction of metal oxide-containing material comprises H₂O addition conduits that are capable of introducing liquid water H₂O_{f} and/or gaseous water H₂O_{g}—i.e. steam—into conduits that conduct
fuel gas
or
components of the fuel gas.

For example, an H₂O addition conduit can open into a fuel gas-conducting conduit. Or it can open into a conduit that conducts a component of the fuel gas, for example into a supply conduit for supply of a portion of the tops gas as fuel gas component to the at least one gas burner; the opening may be disposed upstream and/or downstream—viewed in flow direction toward the gas burner—of openings of feed conduits.

In one embodiment, the apparatus for reduction of metal oxide-containing material comprises a dry dedusting apparatus for dry dedusting of tops gas; this is preferably suitable for dry dedusting of at least a portion of the tops gas provided for use as a component of the fuel gas.

The present application further provides a signal processing device having machine-readable program code, characterized in that it includes open-loop and/or closed-loop control commands for performance of a process of the invention. A further subject is a signal processing device to perform a process as claimed in any of claims 1 to 5.

The present application further provides machine-readable program code for a signal processing device, characterized in that the program code comprises open-loop and/or closed-loop control commands that cause the signal processing device to perform a process of the invention. further subject is a computer program product comprising commands for a signal processing device which, on execution of the program for the signal processing device, cause it to perform the process as claimed in any of claims 1 to 5.

The present application further provides a storage medium with a machine-readable program code of the invention stored thereon. A further subject is a storage medium having a computer program stored thereon for performance of a process as claimed in any of claims 1 to 5.

### BRIEF DESCRIPTION OF THE DRAWINGS

The present invention is described by way of example below with reference to multiple schematic figures.

FIG. 1 shows a schematic of one embodiment of an apparatus of the invention.

FIG. 2 shows a schematic of an embodiment largely analogous to FIG. 1 with details of H₂O addition conduits.

FIG. 3 shows a schematic of an embodiment largely analogous to FIGS. 1 and 2 with details of the dry dedusting.

FIG. 4 shows a schematic of a further embodiment of an apparatus of the invention.

FIG. 5 shows a schematic of a variant of the utilization of tops gas not used for fuel gas.

### DESCRIPTION OF THE EMBODIMENTS

### EXAMPLES

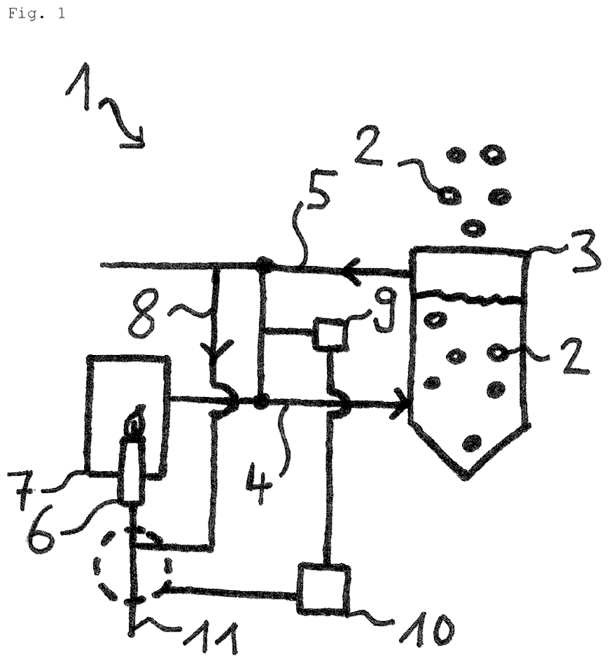

FIG. 1 shows a schematic of an apparatus 1 for reduction of metal oxide-containing material 2 having a reduction reactor 3. The metal oxide-containing material 2 is introduced into the reduction reactor 3. The apparatus 1 for reduction of metal oxide-containing material 2 also comprises a reduction gas feed 4 via which the reduction reactor 3 is supplied with reduction gas containing at least hydrogen and optionally also carbon carriers. By means of a tops gas outlet 5, a hydrogen-containing tops gas is discharged from the reduction reactor 3. Reduction gas is prepared in a preparation plant 7 comprising a gas burner 6 for preparation of reduction gas. The gas burner 6 is operated with fuel gas. A portion of the tops gas is fed to the gas burner 6 as a fuel gas component; this is done via a supply conduit 8 for supply of a portion of the tops gas as fuel gas component to the gas burner 6. There is also an apparatus 9 for determination of the hydrogen present in the reduction gas and in the tops gas. This is used to detect whether an increase in the proportion of hydrogen in the reduction gas and/or in the tops gas occurs. The positions shown, where the proportion of the hydrogen is determined, should not necessarily be provided as illustrated in FIG. 1; the proportion of the hydrogen would also be determinable at different positions; for example, it could be determined after a dry dedusting. With reference to the hydrogen content in the reduction gas and/or in the tops gas, an apparatus 10 for open-loop and/or closed-loop control of the steam content in the fuel gas which is likewise present is used to implement an increase in the steam content of the fuel gas, illustrated by a dashed circle around subsections of conduits that conduct fuel gas components or fuel gas to the gas burner 6. A further fuel gas component is directed to the gas burner 6 via feed conduit 11; tops gas and further fuel gas component are combined in the diagram because the conduit 11 and the supply conduit 8 merge; combination of the further fuel gas component and the tops gas gives rise to fuel gas which is directed to the gas burner 6.

In one variant, the apparatus 10 for open-loop and/or closed-loop control of the steam content in the fuel gas with reference to the hydrogen content in the reduction gas and/or in the tops gas comprises a gas conditioner, which is not shown separately for better clarity. The gas conditioner is configured such that it can be operated at different water temperatures. For this purpose, it may have, for example, different water feeds that are each connected to water from water sources at different temperatures. For this purpose, it may have, for example, heating devices and/or cooling devices for heating and/or cooling of water fed in. In this way, an increase in the steam content of the fuel gas is implemented by increasing the temperature of the water used in the conditioning of the portion of the tops gas.

In a variant which is not shown separately, the gas conditioner has fuel gas conditioning channels having a water feed for fuel gas conditioning, and reduction gas conditioning channels having a hot water feed for reduction gas conditioning. The hot water feed for reduction gas conditioning is suitable here for supplying hot water to at least one fuel gas conditioning channel for fuel gas conditioning. Then the temperature of the water used in the conditioning of this portion of the tops gas can be increased by using hot water provided for the conditioning of tops gas provided as a component of the reduction gas.

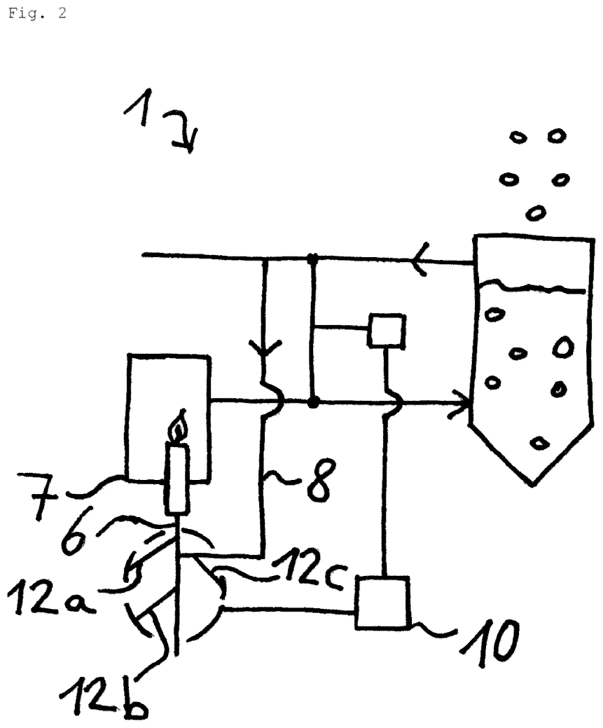

FIG. 2 shows, in a representation largely analogous to FIG. 1, how H₂O addition conduits 12a, 12b, 12c are present. These are used to introduce liquid water H₂O_{f} and/or gaseous water H₂O_{g}—i.e. steam—into conduits that conduct fuel gas or components of the fuel gas. H₂O addition conduit 12a opens into a fuel gas-conducting conduit. H₂O addition conduits 12b and 12c open into conduits that conduct components of the fuel gas. It is thus possible to implement the increase in the steam content of the fuel gas by adding water H₂O to the fuel gas—or to a precursor of the fuel gas or to a component of the fuel gas.

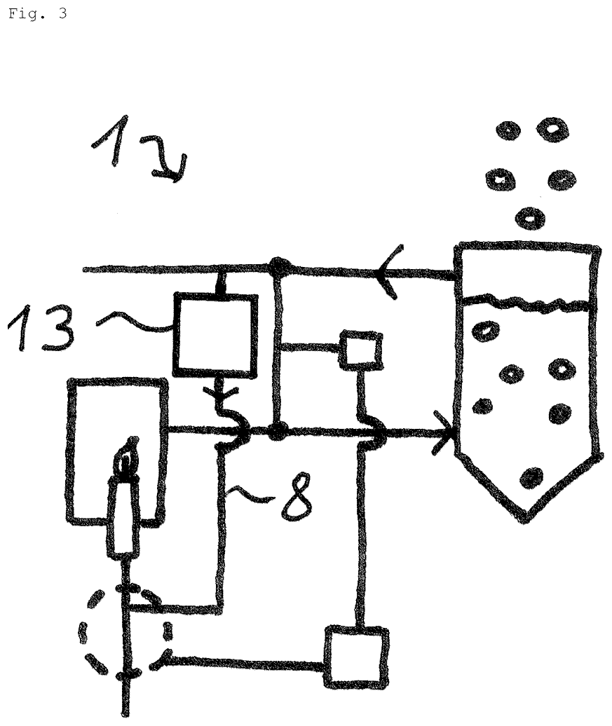

FIG. 3 shows, in a representation largely analogous to FIGS. 1 and 2, how the apparatus 1 for reduction of metal oxide-containing material contains a dry dedusting apparatus 13 for dry dedusting of tops gas. This is suitable for dry dedusting of at least a portion of the tops gas provided for use as a component of the fuel gas, since it is disposed in the supply conduit 8. In a variant which is not shown separately, the apparatus 10 for open-loop and/or closed-loop control of the steam content in the fuel gas may be executed such that it can influence the temperature in the dry dedusting apparatus and in this way open-loop and/or closed-loop control of the steam content in the fuel gas is possible.

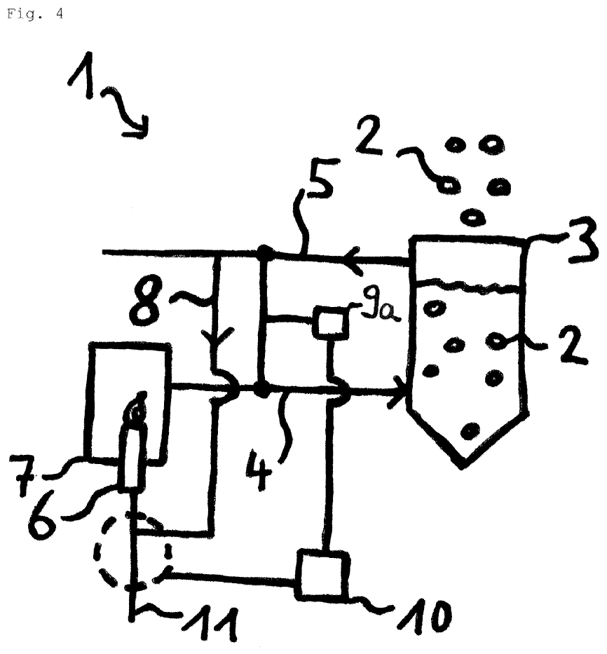

FIG. 4 shows, largely analogously to FIG. 1, a schematic of an apparatus 1 for reduction of metal oxide-containing material 2 with a reduction reactor 3. The metal oxide-containing material 2 is introduced into the reduction reactor 3. The apparatus 1 for reduction of metal oxide-containing material 2 also comprises a reduction gas feed 4 via which the reduction reactor 3 is supplied with reduction gas containing at least hydrogen, and optionally also carbon carriers. A hydrogen-containing tops gas is discharged from the reduction reactor 3 via a tops gas outlet 5. Reduction gas is prepared in a preparation plant 7, comprising a gas burner 6, for preparation of reduction gas. The gas burner 6 is operated with fuel gas. A portion of the tops gas is fed to the gas burner 6 as a fuel gas component; this is done via a supply conduit 8 for supply of a portion of the tops gas as fuel gas component to the gas burner 6. There is also an apparatus 9a for detection of an increase in the proportion of hydrogen in the reduction gas and/or in the tops gas. This apparatus 9a detects whether an increase in the proportion of hydrogen occurs in the reduction gas and/or in the tops gas. The positions shown, where the proportion of hydrogen is determined, do not necessarily have to be provided as illustrated in FIG. 4; it would also be possible to determine the proportion of hydrogen at other positions; for example, it could be determined after a dry dedusting.

The apparatus 9a for detecting an increase in the proportion of hydrogen in the reduction gas and/or in the tops gas, in the case described, is an apparatus for determination of the hydrogen content in the reduction gas and/or in the tops gas. With reference to the hydrogen content in the reduction gas and/or in the tops gas, an apparatus 10 which is likewise present for open-loop and/or closed-loop control of the steam content in the fuel gas is used to implement an increase in the steam content of the fuel gas, illustrated by a dashed circle around subsections of conduits that conduct fuel gas components or fuel gas to the gas burner 6. A further fuel gas component is directed to the gas burner 6 via feed conduit 11; tops gas and further fuel gas component are combined in the diagram because conduit 11 and supply conduit 8 merge; combination of the further fuel gas component and the tops gas gives rise to fuel gas which is directed to the gas burner 6.

In one variant, the apparatus 10 for open-loop and/or closed-loop control of the steam content in the fuel gas with reference to the hydrogen content in the reduction gas and/or in the tops gas comprises a gas conditioner, which is not shown separately for better clarity. The gas conditioner is configured such that it can be operated at different water temperatures. For this purpose, it may, for example, have different water feeds that are each connected with water from water sources at different temperatures. For this purpose, it may, for example, have heating devices and/or cooling devices for heating and/or cooling of water fed in. This implements the increase in the steam content of the fuel gas by increasing the temperature of the water used in the conditioning of the portion of the tops gas.

In a variant which is not shown separately, the gas conditioner has fuel gas conditioning channels with a water feed for fuel gas conditioning, and reduction gas conditioning channels with a hot water feed for reduction gas conditioning. The hot water supply for reduction gas conditioning is suitable here for supplying hot water for fuel gas conditioning to at least one fuel gas conditioning channel. Then the temperature of the water used in the conditioning of this portion of the tops gas can be increased by using hot water provided for the conditioning of tops gas provided as a component of the reduction gas.

The details shown in FIGS. 2 and 3, analogously to their combination with details from FIG. 1, would also be combinable with details from FIG. 4 rather than with details from FIG. 1.

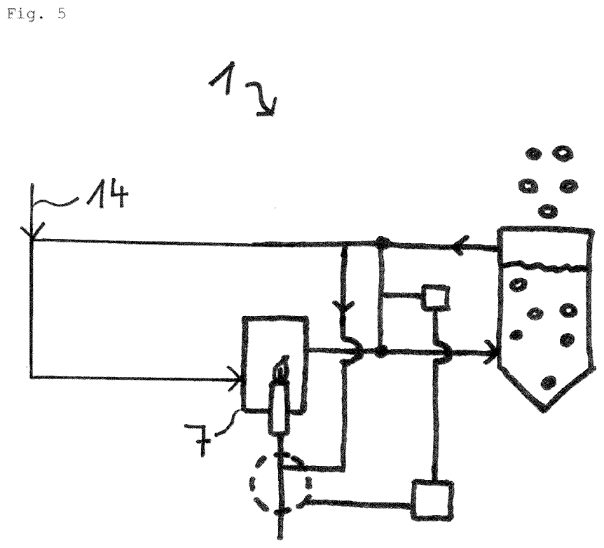

For better clarity, FIGS. 1 to 4 did not show what can be done with tops gas which is not utilized as a fuel gas component. FIG. 5 shows a schematic of how a variant of such utilization can be effected, in an illustration analogous to FIG. 1—tops gas is combined with a reduction gas precursor 14, for example natural gas and/or hydrogen, and the mixture is introduced into the preparation plant for preparation of reduction gas. Tops gas thus serves as reduction gas precursor. Such a recirculation of tops gas and utilization thereof in the preparation of reduction gas is known and is therefore not described in detail. It would also be possible to combine this variant which is shown in FIG. 5 with regard to utilization of the tops gas not utilized as fuel gas component with the details shown in FIGS. 2 to 4.

The feed conduit 11 in FIGS. 1, 3, and 4 is optional; there are also possible embodiments analogous to FIGS. 1, 3 and 4 without feed conduit 11.

### LIST OF REFERENCE NUMERALS

1 apparatus for reduction of metal oxide-containing material
2 metal oxide-containing material
3 reduction reactor
4 reduction gas feed
5 tops gas outlet
6 gas burner
7 preparation plant for preparation of reduction gas supply conduit
9 apparatus for determination of the steam content in the reduction gas and/or in the tops gas
9a apparatus for detection of an increase in the proportion of hydrogen in the reduction gas and in the tops gas
10 apparatus for open-loop and/or closed-loop control of the steam content in the fuel gas
11 feed conduit
12a, 12b, 12c H₂O addition conduits
13 dry dedusting apparatus
14 reduction gas precursor

1. A process for reducing metal oxide-containing material, wherein a reduction gas containing at least hydrogen is fed to a reduction reactor containing the metal oxide-containing material, and a hydrogen-containing tops gas is discharged from the reduction reactor, and whreein portion of the tops gas is fed to gas burners used in the preparation of the reduction gas as a component of the fuel gas, and, in the event of an increase in the proportion of hydrogen in the reduction gas and/or in the tops gas, an increase in the steam content of the fuel gas is implemented.

2. The process as claimed in claim 1, wherein the tops gas is subjected to countercurrent conditioning with water in a gas conditioner, characterized in that the increase in the steam content of the fuel gas is implemented by increasing the temperature of the water used in the conditioning of the portion of the tops gas.

3. The process as claimed in claim 2, characterized in that the temperature of the water which is used for the conditioning of the portion of the tops gas provided as a component of the fuel gas is increased by using hot water intended for the conditioning of tops gas provided as a component of the reduction gas.

4. The process as claimed in claim 1 wherein the increase in the steam content of the fuel gas is implemented by adding water H₂O to the fuel gas and/or to a precursor of the fuel gas and/or to a component of the fuel gas.

5. The process as claimed in claim 1, wherein the tops gas provided for use as a component of the fuel gas is subjected to at least partial dry dedusting.

6. An apparatus for reduction of metal oxide-containing material, comprising:
a reduction reactor
a tops gas outlet for discharge of tops gas from the reduction reactor,
a preparation plant for preparation of reduction gas, comprising at least one gas burner,
a supply conduit for supply of a portion of the tops gas as fuel gas component to the at least one gas burner,
at least one member from the group consisting of the following two members:
a) at least one apparatus for determination of the steam content in the reduction gas and/or in the tops gas,
and
b) an apparatus for detection of any increase in the content of hydrogen in the reduction gas and/or in the tops gas, and
an apparatus for open-loop and/or closed-loop control of the steam content in the fuel gas with reference to the hydrogen content in the reduction gas and/or in the tops gas.

7. The apparatus as claimed in claim 6, wherein the apparatus for open-loop and/or closed-loop control of the steam content in the fuel gas with reference to the hydrogen content in the reduction gas and/or in the tops gas comprises at least one gas conditioner.

8. The apparatus as claimed in claim 7, wherein the gas conditioner has fuel gas conditioning channels for conditioning of tops gas provided as a component of the fuel gas with a water feed for fuel gas conditioning, and reduction gas conditioning channels for conditioning of tops gas provided as a component of the reduction gas with a hot water feed for reduction gas conditioning, wherein the hot water feed for reduction gas conditioning is suitable for supply of hot water for fuel gas conditioning to at least one fuel gas conditioning channel.

9. The apparatus as claimed in claim 6, wherein the apparatus for reduction of metal oxide-containing material comprises H₂O addition conduits that are capable of introducing liquid water H₂Of and/or gaseous water H₂Og into conduits that conduct
fuel gas
or
components of the fuel gas.

10. The apparatus as claimed in claim 6, further comprising a dry dedusting apparatus for dry dedusting of tops gas, preferably suitable for dry dedusting of at least a portion of the tops gas provided for use as a component of the fuel gas.

11. A signal processing device programmed with machine-readable program code and comprising open-loop and/or closed-loop control commands for performing the process of claim 1.

12. A non-transitory computer-readable medium having recorded thereon machine-readable program code for a signal processing device, wherein the program code includes open-loop and/or closed-loop control commands that cause the signal processing device to perform a process as claimed in claim 1.

13. (canceled)

14. The process as claimed in claim 1, wherein the reduction gas further contains carbon carriers.
